(19) United States
(12) Patent Application Publication
(10) Pub. No.: US 2011/0048581 A1
(43) Pub. Date: Mar. 3, 2011

(54) Single post convertible split wedge system

(76) Inventor: Norman A. Hicks, Coudersport, PA (US)

(21) Appl. No.: 12/584,251

(22) Filed: Sep. 3, 2009

(51) Int. Cl. B27L 7/06

(52) U.S. Cl. 144/195.8; 144/195.1

(57) ABSTRACT

This log splitter is designed to work very fast and efficiently, yet be less expensive to construct than comparable splitters. By using a single, vertical, rectangular post to support all the split wedges including the two-way, these wedges can be of a simpler, less expensive, yet as strong construction. Secondly, by angling the Split Wedge Post slightly forward, it retains the split wedges during splitting operations, limits them to rise only slightly as the wood passes through, yet allows them to be freely and easily placed and removed by hand by the operator. The manually operated Height Adjuster Bar located conveniently on the side of the beam, allows the operator to easily and quickly raise and lower the split wedges as necessary to accommodate different sized logs and to retain the wedges in place with a simple latch type arrangement.

### CROSS-REFERENCE TO RELATED APPLICATIONS

### U.S. Patent Documents

| | | |
|---|---|---|
| 4,353,401 | Oct. 12, 1982 | Schilling |
| 4,391,312 | Jul. 5, 1983 | Sakraida |
| 4,860,806 | Aug. 29, 1989 | Brace |
| 5,337,810 | Aug. 16, 1994 | McCormack |
| 5,957,175 | Sep. 28, 1999 | Smith |
| 6,991,010 | Jan. 31, 2006 | Smith |
| 7,108,029 | Sep. 19, 2006 | Albright |
| 7,134,464 | Nov. 14, 2006 | Walker et al |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

not Applicable

### BACKGROUND OF THE INVENTION

Log splitters of various sorts have been around for a long time. Hydraulically powered splitters have become the most common type of log splitter. The relatively slow speed but high power of hydraulic cylinders makes them the best choice for splitters. To improve the speed and efficiency of log splitters, four-way, six-way, and even more than six-way split wedges have been added. These improve the efficiency of splitting by doing multiple splits on each pass, but add the problem of holding the extra blades in place against 22 to 31 tons of hydraulic pressure. The rest of par. 05 continues in the new par. 05.

Most of the regular splitters have fixed, two-way wedges with sharp front edges, welded to the beam. Mostly these are not designed for or good for supporting slip over four-way or six-way wedges. One company sells a four-way that does slip down over the sharp front edge of the two-way wedge. This system is not good because it very soon jams into the sharp blade of the two-way wedge, dulls it, and also is not readily capable of being raised or lowered frequently which is necessary to accommodate the different diameter logs being split. Brace (U.S. Pat. No. 4,860,806) overcomes this by having a wide flare at the rear of the vertical two-way wedge. This flare supports the add-on blades without damaging the two-way blade but at the expense of kicking the split pieces way out to the sides. This would not work well if the operator wanted to use a self-loading system such as an elevator to load the split pieces of wood,

Other companies avoid this problem by adding a separate rectangular vertical bar with a flat front edge right behind the sharp two-way wedge. The four-way and six-way wedges then slide up and down on this bar This system works much better because the flat front edge prevents the four-way or six-way wedge from getting jammed in place. These wedges have to be free to move up and down according to the diameter of the logs they are splitting. The exception being to move the log up and down against a fixed split wedge as in (Albright, U.S. Pat. No. 7,108,629).

Using a second, non-sharp post to elevate the different split wedges requires the blades to extend forward an extra 6 to 8 inches to bring the splitting edges nearly even with the splitting edge of the basic two-way wedge. This requires a much stronger, heavier construction. Also it requires the vertical member each split wedge to be built high enough to accommodate the largest logs anticipated to be encountered. (Some of the high-end commercial splitters have 15-16 inch high, fixed, vertical blades.)

The other problem is how to regulate the height of the four-way and six-way wedges. One company has one inch and two inch spacers that fit on the post under the wedges. However, this system requires those wedges to be lifted off the support bar and replaced for each change of height. This is a very slow system though initially quite inexpensive.

Other companies use a separate hydraulic cylinder to raise or lower the four-way and six-way wedges to the desired heights. This system is very fast and precise but is expensive to install.

### BRIEF SUMMARY OF THE INVENTION

The Single Post Convertible Split Wedge System eliminate the problems of the other systems by utilizing a single post called the Split Wedge Post (FIG. 5, No.1) to support all the split wedges including the two-way. This post is rectangular with no cutting edge. All three (or more) split wedges including the basic two-way wedge slide down over it and are supported by it. It takes all the force of the 22 to 31 tons of hydraulic pressure exerted against the various split wedges and holds solidly as they split the logs into separate pieces. This allows lighter, simpler, less expensive, more efficient construction of the four-way, six-way, or more-than-six-way wedges.

A slight forward inclination of the Split Wedge Post keeps the various split wedges in place while still allowing them to be easily removed and replaced during changeovers.

Fast, simple to do height adjustments are essential for any degree of efficiency with the four-way and six-way wedges. The Height Adjuster Bar (FIG. 5, No. 10) does this at a fraction of the cost of a hydraulically operated height adjuster and in a fraction of the time necessary for spacers to be changed around.

The Height Adjuster Bar (FIG. 5, No. 10) pivots off center to allow for easier adjustment. The left end lifts the split wedge; the right end is pushed down accordingly and locks in place with a small lever operated pin. The off-center mounting of the bar allows a few pounds of force to easily lift a heavy four-way or six-way wedge into position.

### BRIEF DESCRIPTION OF THE SEVERAL VIEWS OF THE DRAWING

Page 1, FIG. 1 Shows a side view of the splitter with a four-way wedge installed. The dotted lines illustrate how high the split wedge can be raised and the position of the Height Adjuster Bar (No. 10) when the wedge is raised to its full height.

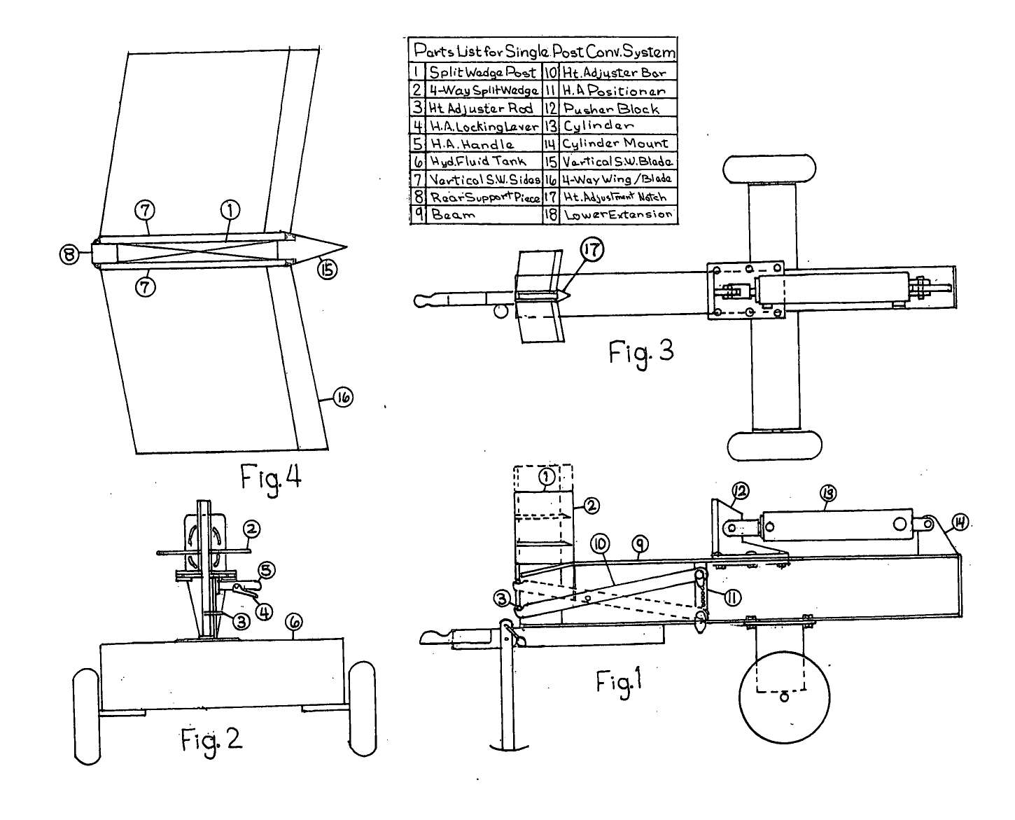

the Page 1, FIG. 2 Shows an end view of the splitter. Notice wings (No. 16) of the four-way split wedge, the little but very important Height Adjuster Rod (No. 3), and the Height Adjuster Locking Lever (No. 4) on the handle of the Height Adjuster Bar (No. 10).

Page 1, FIG. 3 The top view of the splitter. Notice the V-shaped hole, the Split Wedge Notch (No. 17) in front of the Split Wedge Post. This is to accommodate the downward extensions of each split wedge.

Page 1, FIG. 4 This is a detailed view of the 4-way split wedge showing how the wings (No. 16) angle forward to retain the split wood and the central space (No. 1) for the Split Wedge Post. It also shows quite clearly how these wings are securely welded to the vertical split wedge right at their bases rather than 6 to 8 inches back, thus allowing superior strength yet with less weight.

Page 2, FIG. 5 This is an isometric view of the splitter and much more readable. Notice the Split Wedge Notch (FIGS. 3, 5, No. 17) just ahead of the Split Wedge Post (FIG. 5, No. 1). This is to accommodate the lower extension of the vertical cutting edges of the various split wedges. This extension allows the split wedges to maintain a sharp cutting edge clear down to the beam even when they are raised up for larger logs. (This extension of the cutting edge is critical to the whole design. Without it when the wedges would be raised, there would be no cutting edge at the bottom, and the unsplit portion of the logs could hang up on the flat front edge of the Split Wedge Post (FIG. 5, No. 1).

Page 2, FIG. 6 This is a picture of the two-way split wedge. This unique wedge is the largest change in the design. This allows a single post, the Split Wedge Post (FIG. 5, No. 1) to be placed in a favorable location on the beam, and support each of the various split wedges. It allows for a shorter, lighter beam, lighter yet as strong split wedges, and fast, no tools interchange of the split wedges.

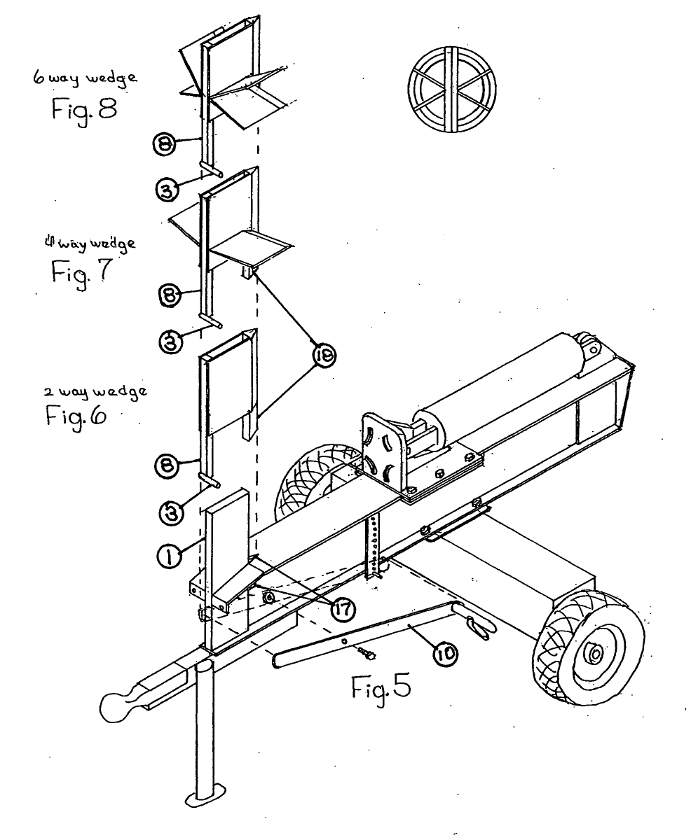

Page 2, FIG. 7 This is the four-way wedge. Notice the Height Adjuster Rod (No. 3) attached to the Rear Support Piece (FIGS. 4, 5, 6, 7, No. 8). This is what the Height Adjuster Bar (FIG. 5, No. 10) moves as it supports, raises, and lowers each of these split wedges.

Page 2, FIG. 8 This is the six-way wedge. Because these blades are supported right at their bases, they do not need to be as massive as with other split wedge designs. This allows them to split the wood cleanly yet with less power needed.

### DETAILED DESCRIPTION OF THE INVENTION

First of all, this basic design of splitter is the standard design of most splitters.

The differences are, first, in the beam. In this plan it is 11 inches high though the design is not limited to these dimensions. This extra height is necessary to be strong enough to withstand the enormous pressures against the split wedges that are a minimum of 12 inches high and can be raised up to 16 inches high. The beam is notched to accommodate the Split Wedge Post and the cutting edge extensions of the split wedges. The Split Wedge Post (FIGS. 5, 1, No. 1) is angled forward slightly (about 5 degrees here) to keep the logs from raring up as they are forced into the split wedges.

The pusher block is built of standard construction with spacers and holders bolted to the bottom plate to hold it in place. A large ¾×7×10 HR flat is used for the actual pusher block. It is backed by a 1×10×10 piece of HR flat with a 1 inch hole to attach to the cylinder. Small pieces of steel are welded to the face of the pusher block to prevent the logs from slipping out of place as they are being forced through the splitter blades.

The split wedges all start out the same, with ¼×7×12 special high strength steel flat sides, a 1¼×3×17½ inch bar stock shaped to a sharp edge in front and notches in the back to receive the sides. (In cross section, it looks like an arrow head.) The rear of the “box” is the Rear Support Piece (FIGS. 4, 6, 7, 8, No. 8) which is ¾×1×19 inches HR flat. These are assembled with thin shims on the sides to allow the width of the “box” to be slightly wider than the ¾ inch wide bar they will slide down over. Also the ends will be spaced slightly farther apart than the 6 inch width of the Split Wedge Bar. The top ends of all four pieces will be even. These will be welded securely together. The Height Adjuster Rod (FIGS. 6, 7, 8, No. 3) will be welded to the bottom of the Rear Support Piece (FIG. 6, 7, 8, No. 8). This completes the two-way wedge.

The ¼×8×8 inch wings for the four-way are cut from special high strength steel or similar material at an 80 degree angle rather than the usual 90 degree angle to keep the split logs from sliding off sideways without being split again. The leading edges are milled at 30 degrees to a cutting edge. These four-way wings are welded on securely at 3 inches above the bottom of the sides although this could be varied according to the desires of customers without affecting this overall design. At first thought, one might wonder why they were not welded on at 6 inches, the middle of the split wedge. The answer is that much if not most firewood is split to a thickness of about 3 inches. If one wishes to have larger pieces, he can just raise the split wedge up to a maximum of 7 inches. This placement of the wings gives the operator maximum flexibility in splitting wood to meet most needs. With the split wedge up to its maximum height of 7 inches, one can split a larger log into quarters, and then lower the split wedge and split each quarter into four smaller pieces.

The six-way split wedge starts with the same basic two-way core structure. Four wings are cut this time, the same size as the four-way wings. The inner edges of the lower wings are welded on to the sides of the two-way wedge core structure, 4 inches up from its bottom edges and angled down at 30 degrees. The upper wings are set just above the lower wings, at a 30 degree angle upward, and welded on securely. This gives an even 60 degrees between each cutting edge. The 4 inch placement allows this split wedge to split to the center of 8 to 16 inch diameter logs on the first pass.

1-6. (canceled)

7. A wood splitting apparatus comprising of a horizontally positioned beam mounted on a trailerable frame, a pusher block actuated by a hydraulic cylinder powered by a gasoline or diesel engine, and mounted on one end of said beam, and a fixed, rectangular, vertical Split Wedge Post on the other end upon which can be mounted a variety of freely removable, slide-on split wedges, which can be manually adjusted vertically up and down by the Height Adjuster Bar.

8. The wood splitter of claim 7, wherein a single, nearly vertical, rectangular post with no sharp, cutting edges, hereinafter called the Split Wedge Post (FIG. 5, No.1), is welded permanently to the other end of the beam from the hydraulic cylinder mount (FIG. 1, No.14), angled forward slightly to allow slight but restrained upward movement of the split wedges during splitting (about 5 degrees in this plan but not restricted to this amount).

9. The Split Wedge Post of claim 8. wherein each split wedge including the two-way wedge can be easily slid on and off the Split Wedge Post by hand, in seconds, without tools.

10. The wood splitter of claim 7, wherein the four-way, six-way, etc. split wedges are completed by welding or otherwise attaching the extra blades directly to the sides of a basic two-way split wedge structure, thus allowing for a simpler, lighter, yet just as strong, construction.

11. The split wedge of claim 10, wherein the vertical wedge component of each split wedge is built with a downward extension that goes downward through a special opening in the beam thereby allowing a vertical cutting edge clear down to the beam even when the split wedges are fully extended upward.

12. The wood splitter of claim 1, wherein the manually operated, Height Adjuster Bar makes fast, simple, height adjustments to the various split wedges without the need for extra hydraulic cylinders, control valves, hosing, or tools.
